(19) United States
(12) Patent Application Publication
(10) Pub. No.: US 2004/0048535 A1
(43) Pub. Date: Mar. 11, 2004

(54) Composite material for use in equestrian applications

(76) Inventor: Richard J. Sacks, Aptos, CA (US)

Correspondence Address: CENTRAL COAST PATENT AGENCY, PO BOX 187, AROMAS, CA, 95004, US

(21) Appl. No.: 10/654,795

(22) Filed: Sep. 3, 2003

Related U.S. Application Data
(60) Provisional application No. 60/410,201, filed on Sep. 11, 2002.

(51) Int. Cl. B32B 27/12; B32B 27/04; D04H 1/00; D04H 1/46; B32B 5/06; B32B 5/26; B32B 3/06

(52) U.S. Cl. 442/133; 428/317.9; 428/306.6; 442/131; 442/270; 442/277; 442/285; 442/393; 442/402; 442/417; 442/389; 442/394; 442/414

(57) ABSTRACT

Composite structures and methods are taught relating to temperature stabilizing saddle pads, horse blankets, saddle girths, saddle seat cushions, and saddles for protection and increased performance of horses and/or riders, among other similar products. The invention provides for products that stabilize the temperature of the horse and/or the rider by absorbing heat generated by the body of the horse and/or rider when the temperature exceeds a preset temperature appropriate for the product. In this process heat energy is absorbed through phase change, resulting in a constant temperature as long as there is material that has not changed phase.

### CROSS-REFERENCE TO RELATED APPLICATIONS

The present invention claims priority to co-pending provisional application serial number 60/410,201 filed on Sep. 11, 2002. This prior provisional application is incorporated herein in its entirety by reference.

### FIELD OF THE INVENTION

The present invention is in the area of accessory equipment for equestrian applications, and pertains particularly to products incorporating temperature stabilizing materials for such as saddle pads, horse blankets, and the like.

### BACKGROUND OF THE INVENTION

At the time of the present patent application there are many accessory products, including saddle pads, horse blankets, saddle girths, saddle seat cushions, and saddles for protection and increased performance of horses and/or riders, in the equestrian market for providing fit and comfort for both horses and riders. It is the inventor's experience, however that there remain many problems with such products, and there are many unmet needs.

Prior to the present invention, saddle pads and such items were made primarily from a single or multiple types of padding material such as wool, felt, open and closed cell foams, gels, honeycombed plastics, neoprene or a variety of other materials, in an effort to provide cushioning between the animal and the load being applied to its back. Horse blankets were made primarily from woolen or synthetic materials to allow for protection from dirt, mud, moisture, and to provide a degree of thermal protection from outside elements. Saddle girths have primarily been made from leather, wool, or a variety of synthetic materials including foam and neoprene to provide a firm attachment of a saddle to the horse's back. Saddle cushions have been made from a variety of materials as well, including leather, suede, gels, and open and closed cell foams, with the primary focus of providing protection and comfort for the rider's anatomy when seated in the saddle. Some of the cushions have been incorporated into the construction of the saddle itself. Saddles have been previously been made from leather or synthetic materials and are designed to provide a secure seat on the animal's back for the rider.

Among the problems and unmet needs in this area include that such products, in their attempts to achieve their specific goals, provide limited levels of breathe-ability for ventilation, and/or cooling, and/or thermal management of the horse and/or rider. Following is a more specific list of the difficulties in this art:

1. Incorrect fit between saddle tree bars and a horse's back. (most saddles do not fit properly in a static environment and virtually none fit correctly in a dynamic environment)

2. Pressure points created by combination of downward weight of the saddle and rider, and ill fitting saddles on the horse's back lead to soreness and lesions.

3. Retention of body heat by the horse causes internal overheating. This is a result of existing products not allowing the perspiration of the horse to adequately vent and evaporate, or to be wicked away from the horse's body.

4. Poor hygienic environment created by the combination of sweat, heat and the inability to wash or launder existing products.

In light of these many unmet needs, what is clearly needed is a way, considering products that come into contact with a horse, or interpose between a horse's flesh and a rider, to provide for better fit, sophisticated temperature management, and an improved hygienic environment. Apparatus and methods described in enabling detail below as embodiments of the present invention provide just such improvements, resulting in substantially improved products.

### SUMMARY OF THE INVENTION

In a preferred embodiment of the present invention composite materials and methods are taught relating to temperature stabilizing products such as saddle pads, horse blankets, saddle girths, saddle seat cushions, and saddles for protection and increased performance of horses and/or riders. More specifically the invention provides for products that stabilize the temperature of the horse and/or rider by absorbing heat generated by the body of the horse and/or rider when the temperature exceeds a specific temperature. In this process, in preferred embodiments, heat energy is absorbed through phase change, resulting in a constant temperature as long as there is material that has not changed phase.

The temperature stabilization is accomplished through a novel use of phase-change material. When the interface temperature tends upward at the phase-change temperature, the material absorbs heat. When the interface temperature tends below the phase-change temperature, the novel materials release stored heat to keep the temperature from falling further. The horse and/or rider's body heat and the ambient temperature continually recharge and recycle the products to help keep the horse and/or rider's temperature balanced and comfortable, thereby protecting and improving the performance of the horse and/or rider.

In a preferred embodiment of the invention a composite structure for use in contact with an animal's flesh is provided, comprising one or more layers of padding material, and a phase change material (PCM) joined to one of the layers of padding material. Also in a preferred embodiment the padding material is one or the other of woven or non-woven material, and the PCM is adhered in a plurality of discrete units to individual fibers of the padding material. In another preferred embodiment one of the layers of padding material is an open-celled or closed-cell foam material, and the PCM is coated on individual cells of the foam material.

In another embodiment there is a first layer of felt material, disposed to lie next to the animals flesh, and a second layer comprising non-woven PCM-coated sheet material applied to the felt on the side away from the animal's flesh. In some cases the second layer is applied to the first layer by needle-pointing. Further, there may be two layers of felt material with a layer of PCM-enhanced material sandwiched between the layers of felt. In a preferred embodiment the PCM material is chosen to be a material for which the phase-change temperature is about ninety-five degrees Fahrenheit.

In some alternative embodiments there may be a first layer of sheep's wool, disposed to lie next to the animals flesh, and a second layer comprising non-woven PCM-coated sheet material applied to the felt on the side away from the animal's flesh. There may also be one or more layers of anti-bacterial batting material. In still further embodiments there may be one or more layers of material exhibiting high surface friction to provide a non-skid surface.

In some embodiments there are areas of highly wear-resistant material in areas deemed to be subject to relatively more wear than other areas. There may also be a shock-absorbing layer, which can be one an open-celled foam, a visco-elastic material, a gel material, or a closed-cell foam. In embodiments with visco-elastic or open-celled material, at least a 7-pound weight is preferable. In many embodiments a pocket between two layers of padding material for enclosing the shock-absorbing material, and the pocket may have a closure, such as one of a zipper, a set of button s and button-holes, a set of eyelets with laces, or a Velcro™ style closure.

In a further embodiment of the invention at least one layer comprises fiber based on rare earth elements, and optically responsive to both wavelengths of ambient light and energy produced by an animal's body, to interact with the animal in a manner to increase oxygenated blood flow.

### BRIEF DESCRIPTION OF THE DRAWING FIGURES

FIG. 1 is a partial cross-section of a composite panel according to an embodiment of the present invention.

FIG. 2 is a partial cross-section illustrating a composite in an alternative embodiment of the invention.

FIG. 3 is a cross-section of a composite for saddle pads, girth pads, horse blankets, saddle girths, saddle seat cushions, and saddles and the like in another alternative embodiment of the invention.

FIG. 4 is a cross-section of a composite in yet another embodiment of the present invention, particularly useful as a saddle pad.

### DESCRIPTION OF THE PREFERRED EMBODIMENTS

In various embodiments of the present invention a commercially-available material know in the art as phase-change material (PCM) is used in combination with various other materials to provide superior performance for various products in equestrian use. These products include saddle pads for interposing between a horse's flesh and a saddle, saddle seat pads for interposing between a saddle and a rider, horse blankets, and girth pads, among others.

In descriptions of embodiments of the invention below, considerable reference is made to “equestrian, and to horses and the use of such products for horses and riders. It should be understood that all descriptions are exemplary of the invention in various forms, and that the invention may be used in many embodiments for animals other than horses; mules, donkeys, camels, oxen, and many others come to mind.

PCM materials are commercially available from several sources, and in various forms. One company that makes such materials is Frisby Technologies, Inc. of Winston-Salem N.C. Another is Outlast Technologies, Inc. Considerable information relative to the former company may be found on the World Wide Web at Frisby.com. Information on the latter is found at Outlast.com. Both of these companies are owners of a number of patents on PCMs and methods of using same. An example of a patent belonging to Frisby is U.S. Pat. No. 6,270,836. An example of a patent belonging to Outlast is U.S. Pat. No. 6,207,738.

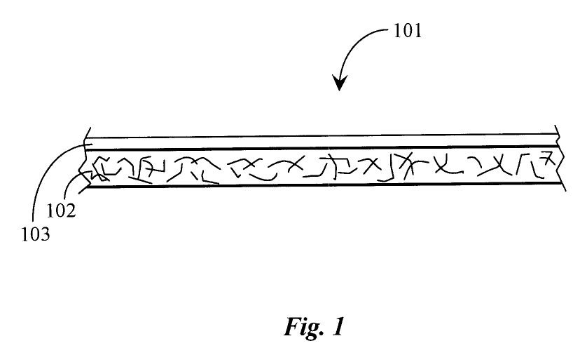

FIG. 1 is a partial cross-section of a composite panel 101 according to an embodiment of the present invention, having a layer of felt material 102 and a layer of non-woven PCM-coated sheet material 103 applied to the felt by needle-pointing. Application may be by any of several methods, but it is preferable that heavy adhesives be avoided, as such adhesive layers may block migration of air and perspiration in the layered material. In various embodiments based on the cross-section of FIG. 1, the felt provides for a region of air movement between the horse's back and the underside of a saddle, and the PCM material provides for phase-change temperature stabilization. PCM material may be applied in a number of ways, such as by coating fibers of a woven or a non-woven fabric with PCM, or by coating cells of an open-celled or a closed-cell foam with PCM. Typically, in applications in the present invention PCM is applied to cells or fibers of other materials that are constructed to allow wicking of moisture and passage of air, specifically to aid in the transfer of heat to and from the PCM during phase change.

Felt is a material regularly used in such as saddle pads, the combination of felt with PCM, however, is novel and advantageous. In the combination in this embodiment the felt layer provides a relatively soft and conformal layer, while allowing heat and perspiration from the horse's body to translate away from the body interface. The PCM layer provides a heat sink to stabilize the temperature at the interface. It is well-known that a phase-change material is a material that changes phase at a particular temperature, absorbing heat as it changes phase in one direction, and releasing heat as it changes phase in the other direction.

In a preferred embodiment a material that changes phase at about ninety-five degrees Fahrenheit is used. Assuming a saddle pad between the horse and saddle with the cross-section construction shown in FIG. 1 and described above, as the horse is exercised vigorously it generates heat at a substantial rate. If the saddle pad were, for example, an impervious layer that prevented air circulation and perspiration evaporation, the temperature under the saddle would rise rapidly, and would only stabilize at some temperature at which the rates of heat transfer through the pad and into the saddle equaled the rate of heat production. Given the pad in the embodiment of the present invention described above, at the phase-change temperature of about ninety-five degrees, the phase-change material begins to change to another phase, and absorbs heat in the process. As long as there is material not yet changed to the alternate phase, the temperature remains at the phase-change temperature of ninety-five degrees, so the temperature under the saddle does not continue to rise, but plateaus, and remains comfortable.

Now, at some point that the vigorous exercise ends, the heat production by the horse abates, and the under-saddle temperature begins to fall. Assuming the ambient temperature of the surrounding environment is less than ninety-five degrees, now the process reverses. The phase-change material begins to release the heat it had absorbed before, as it changes back to its original phase. The result, again, is that the temperature remains at substantially ninety-five degrees as long as there is unchanged material.

It is seen, then, that the saddle blanket described with reference to FIG. 1 as an embodiment of the invention tends to cool the active animal, and warm the inactive animal; a very advantageous result.

Another consideration in the embodiment shown in FIG. 1 and described above, is time. It should be clear that, if there is a relatively small amount of PCM in the saddle blanket overall, then, assuming a fixed rate of heat production for an animal exercising, all of the PCM will change phase in a finite time shorter than the time to the same occurrence (depleted original phase) if there is a greater volume of PCM. So it becomes important to take into consideration when designing such a product, the potential heat production, and the time period one wishes the product to be effective in controlling temperature.

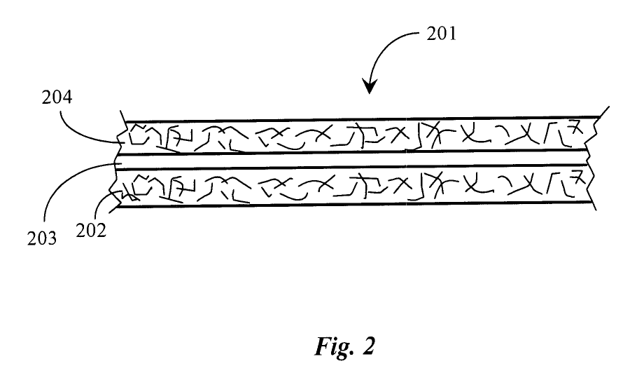

In an alternative embodiment of the invention, illustrated in FIG. 2, a composite 201 is provided wherein the PCM layer 203 is sandwiched between two felt layers 202 and 204. In alternative embodiments with one or two layers of felt, the PCM layer may be non-woven material, woven material, or foam material coated with PCM.

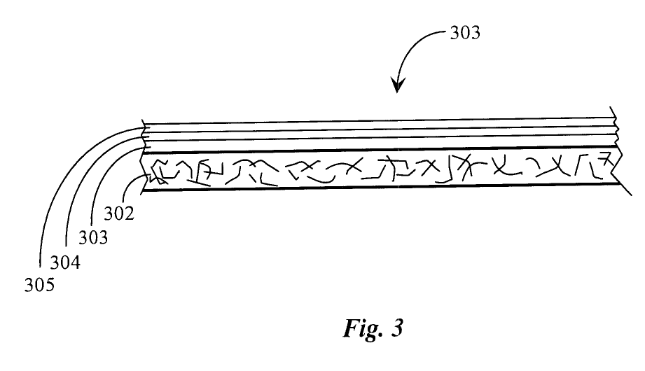

FIG. 3 is a cross-section of a composite 301 for saddle pads, girth pads, horse blankets, saddle girths, saddle seat cushions, and saddles and the like in yet another embodiment of the invention. In this embodiment felt is not used, as felt is a material that cannot be repeatedly washed, and also provides less than ideal breathability. A first layer of sheep's wool 302 is provided to be disposed next to the animal's flesh. The wool has superior wicking ability for moving perspiration, and is open enough for good air circulation. A second layer 303 is a non-woven material bearing the PCM. Layer 304 is an anti-bacterial batting. Layer 305 is a non-skid material, such as, for example canvas duck. This composite wicks perspiration, allows evaporation, and provides the PCM temperature stabilization described above.

In some embodiments based on FIG. 3 there may also be wear-resistant material added at strategic areas that may be subject to extra friction.

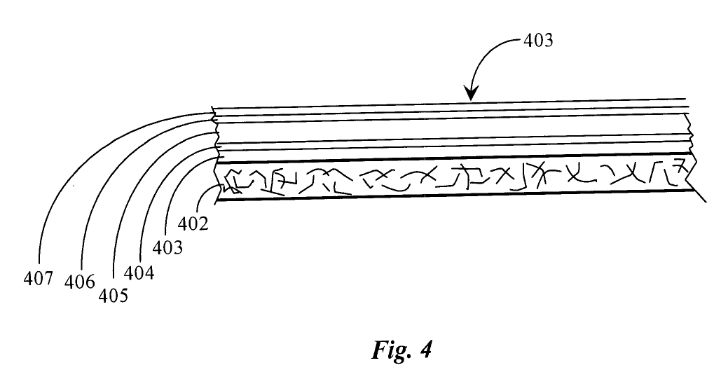

FIG. 4 is a cross-section of a composite 401 in another embodiment of the present invention, particularly useful as a saddle pad. Layer 402 is wool, disposed to be next to the animal's flesh. Layer 403 is PCM-bearing material. Layer 404 is anti-bacterial batting. Layer 405 is a shock absorbing material, such as an open-celled foam, a visco-elastic material, a gel material, or a closed-cell foam. Visco-elastic or open-celled material is preferred, in at least 7-pound weight, as these materials allow circulation and provide good shock absorbancy. Layer 406 is another layer of batting. In a preferred embodiment the construction is such that the two layers of batting are provided as a pocket with a zipper or other closure, such that the shock absorbing material may be removed, so the rest may laundered. Layer 407 is a canvas or other non-skid type material.

Other embodiments are possible, dependent upon the implementation of the phase change material. For example, the phase change material can be directly bonded to a wool felt non-woven material, creating a single layer pad similar to traditional felt pads commonly available but with temperature control capability. Additionally, the phase change material can be impregnated into foam that can be directly applied to the animal's body or used in a layer construction. There are a number of alternatives.

In yet another embodiment of the present invention a textile known as Holofiber™ is used for one or more of the layers, and in other novel ways in a composite for products made to be used next to an animal's flesh, such as a saddle blanket. This material provides for a system the inventor terms the EquiCharge™ Oxygenated Energy Recovery System for horses and other animals. Holofiber™ takes advantage of recent development of smart textiles that are engineered for performance. Holofiber™ is a fiber based on rare earth elements. Holofiber™ is optically responsive to wavelengths of ambient light as well as energy produced by the body. The mechanism involves interaction with cells that include the mitochondria (the power source of the cell), and influences increased oxygen levels in body tissues. This more readily available oxygen results in improved metabolism, an increase in energy as well as faster recovery from exertion.

A double blind clinical study recently proved the effects of Holofiber™ to be compelling and significant. The study was conducted by Lawrence A. Layery, DPM, MPH, an associate professor in the department of orthopedic surgery and rehabilitation at a major university medical center. Under the direction of Dr. Layery, subjects with a history of diabetes and vascular impairment were evaluated. The results of Dr. Lavery's study, using products made with Holofiber™ and as a control, non-Holofiber™ products, indicate measurably increased oxygen levels observed and recorded in the body and blood in subjects wearing the Holofiber™ products. This testing demonstrated that there was a “Statistically significant change in transcutaneous oxygen—or the oxygen delivery to the skin—in hands and feet, on subjects wearing Holofiber™ gloves and socks compared to those wearing comparable non-Holofiber™ gloves and socks.” “The significant changes observed are very compelling for this type of product. An 8 to 12% improvement in skin oxygenation could increase marginal circulation enough to improve wound-healing or eliminate ischemic (localized tissue anemia due to obstruction of the inflow of arterial blood) pain of the legs,” observed Dr. Layery.

The physiology of human and equine cell structure and circulatory systems are very similar. Extensive equine testing is continuing to determine additional benefits. It is expected that at least the same levels of performance found in the Holofiber™ clinical study can apply to horses.

The EquiCharge™ Oxygenated Energy Recovery System with Holofiber™ can increase the blood flow and transcutaneous oxygen transfer to the skin under the saddle pad. This area is typically traumatized by impaired blood flow and tissue damage. The visual manifestation is known as white spots on the withers. The EquiCharge™ Oxygenated Energy Recovery System can greatly minimize the appearance of these white spots. Increased oxygen levels to the back of the horse can also result in improved metabolism, an increase in energy, as well as faster muscle recovery from exertion and strain caused by the rider and the saddle. Similar results can be expected when products (wraps and splint boots) with the EquiCharge™ Oxygenated Energy Recovery System are applied to other areas of the equine body.

The competitive advantages of The EquiCharge™ Oxygen Energy Recovery System are equally compelling. Improved metabolism, increased blood circulation, increased energy and endurance, and faster muscle recovery are normally the result of drugs or supplements. Top level equestrian athletes and their riders want everything they can possibly find to help get the best performance possible. Now, with The EquiCharge™ Oxygenated Energy Recovery System, there is no extra effort and it really benefits your horse. Riders in every discipline, endurance, reining, hunter/jumper, dressage, roping, cutting, eventing and reining, will find they have a competitive advantage.

In the present invention Holofiber™ is used in a unique way not before accomplished, and particularly adaptable to products for horses and other animals. This unique combination provides a layer of material based on wool felt and Holofiber™ in substantially equal proportions in a preferred embodiment. Holofiber™ is mixed with wool fibers prior to making the felt, and after the felt is made, the fibers (both Holofiber™ and wool of the felt) are coated with PCM. This composite material is then used as a layer in a layered structure as described above in various embodiments. In some cases this combo layer of Holofiber™-containing felt with PCM may be the first layer in contact with a horse's flesh, and in other cases there may be one or more intervening layers.

In various embodiments of the invention as illustrated in the several drawings, different layers and construction may be used, and the units provided in different overall thickness and shapes. In many cases the application will determine the layering used. For example, for girth pads and horse blankets shock absorbing material will not be used, as typically unnecessary.

In some embodiments pads may be provided in one or another of the cross-sections described above and used for seat pads on the rider side of a saddle, to provided a temperature-stabilized seat for the rider. In yet another embodiment PCM may be infused into or otherwise integrated with leather portions of a saddle, a bridle, or other leather accessories used in horse riding and management, as a way to provide temperature stabilization. Many sorts of products benefit from following the teachings of various embodiments of the present invention, including but not limited to saddle blankets, seat cushions, exercise and other blankets, polo wraps, sweat collars, girth pads, saddle girths, and splint boots. The invention is limited only by the breadth of the claims below.

What is claimed is:

1. A composite structure for use in contact with an animal's flesh, comprising:
one or more layers of padding material; and
a phase change material (PCM) joined to one of the layers of padding material.

2. The composite structure of claim 1 wherein the padding material is one or the other of woven or non-woven material, and the PCM is adhered in a plurality of discrete units to individual fibers of the padding material.

3. The composite structure of claim 1 wherein one of the layers of padding material is an open-celled or closed-cell foam material, and the PCM is coated on individual cells of the foam material.

4. The composite structure of claim 1 comprising a first layer of felt material, disposed to lie next to the animals flesh, and a second layer comprising non-woven PCM-coated sheet material applied to the felt on the side away from the animal's flesh.

5. The composite structure of claim 4 wherein the second layer is applied to the first layer by needle-pointing.

6. The composite structure of claim 1 comprising two layers of felt material with a layer of PCM-enhanced material sandwiched between the layers of felt.

7. The composite structure of claim 1 wherein the PCM material is chosen to be a material for which the phase-change temperature is about ninety-five degrees Fahrenheit.

8. The composite structure of claim 1 comprising a first layer of sheep's wool, disposed to lie next to the animals flesh, and a second layer comprising non-woven PCM-coated sheet material applied to the felt on the side away from the animal's flesh.

9. The composite structure of claim 1 further comprising one or more layers of anti-bacterial batting material.

10. The composite structure of claim 1 further comprising one or more layers of material exhibiting high surface friction to provide a non-skid surface.

11. The composite structure of claim 1 further comprising areas of highly wear-resistant material in areas deemed to be subject to relatively more wear than other areas.

12. The composite structure of claim 1 further comprising a shock-absorbing layer.

13. The composite structure of claim 12 wherein the shock absorbing material is one an open-celled foam, a visco-elastic material, a gel material, or a closed-cell foam.

14. The composite structure of claim 13 wherein the shock-absorbing material is one of a visco-elastic or open-celled material, in at least 7 pound weight.

15. The composite structure of claim 12 comprising a pocket between two layers of padding material for enclosing the shock-absorbing material.

16. The composite structure of claim 15 wherein the pocket comprises a closure for retaining the shock-absorbing material in the pocket.

17. The composite structure of claim 16 wherein the closure comprises one of a zipper, a set of button s and button-holes, a set of eyelets with laces, or a Velcro™ style closure.

18. The composite structure of claim 1 wherein at least one layer comprises
fiber based on rare earth elements, and optically responsive to both wavelengths of ambient light and energy produced by an animal's body, to interactive with the animal in a manner to increase oxygenated blood flow through cell structure of the flesh.
